(19) United States
(12) Patent Application Publication
(10) Pub. No.: US 2025/0335502 A1
(43) Pub. Date: Oct. 30, 2025

(54) DISPLAY METHOD AND SYSTEM FOR MULTIMEDIA DEVICE

(71) Applicant: WUXI FUTURE MIRROR DISPLAY TECHNOLOGY CO., LTD., Wuxi (CN)

(72) Inventors: Chao YAO, Wuxi (CN); Xinyuan CAO, Wuxi (CN)

(73) Assignee: WUXI FUTURE MIRROR DISPLAY TECHNOLOGY CO., LTD., Wuxi (CN)

(21) Appl. No.: 18/649,692

(22) Filed: Apr. 29, 2024

(30) Foreign Application Priority Data
Apr. 24, 2024 (CN) 202410501120.3

(51) Int. Cl. G06F 16/683; G10H 1/36

(52) U.S. Cl. CPC G06F 16/685; G10H 1/368

(57) ABSTRACT

A display method and system for a multimedia device are provided. The method includes: receiving an operation instruction for the multimedia device, determining whether the received operation instruction matches a preset behavior library, invoking preset response information associated with an audio file if the received operation instruction matches the preset behavior library, and resuming receiving the operation instruction or displaying an alarm prompt if the received operation instruction does not match the preset behavior library; and loading the audio file based on the preset response information, invoking preloaded special effects in the preset response information if the audio file has been loaded, and displaying a standby screen if the audio file failed to be loaded. The audio file is received and recognized. The image is associated with the sound, and is rhythmic and in sync with the sound visually, thereby improving the audio-visual experience.

### FIELD

The present disclosure relates to the technical field of multimedia control, and specifically to a display method and system for a multimedia device.

### BACKGROUND

Users generally choose traditional speakers for playing audios, or choose smart speakers to interact with the speakers for conveniently control the speakers with sound. As smart devices advance, conveying information through sound alone is no longer enough to meet the entertainment needs of the public. Users are also expecting more personalized services and paying increasing attention to visual effects of products. There are currently some speakers that can display lyrics or provide a visual screen that changes with the rhythm. However, such speakers provide relatively simple display effects, and fail to reflect the correlation between the sound and the image. This is not enough to provide users with an immersive music experience.

### SUMMARY

In view of this, a display method and system for a multimedia device are provided according to the present disclosure, to solve the above technical problem.

A display method for a multimedia device is provided according to the present disclosure, to solve the above technical problem. The method includes: receiving an operation instruction for the multimedia device, determining whether the received operation instruction matches a preset behavior library, invoking preset response information associated with an audio file if the received operation instruction matches the preset behavior library, and resuming receiving the operation instruction or displaying an alarm prompt if the received operation instruction does not match the preset behavior library; and loading the audio file based on the preset response information, invoking preloaded special effects in the preset response information if the audio file has been loaded, and displaying a standby screen if the audio file failed to be loaded.

In an embodiment, the preset behavior library comprises a plurality of preset operation instructions individually loaded with preset operation categories and preset operation objects. The operation instruction for the multimedia device is loaded with a target operation category and a target operation object.

In an embodiment, the matching includes: receiving a target operation instruction for the audio file, and acquiring a target operation category and a target operation object; determining whether the target operation object matches one of the preset operation objects after determined that the target operation category matches the corresponding preset operation category; invoking the preset response information associated with the audio file if the target operation object matches a preset operation object; and requesting to re-receive the operation instruction or display an alarm prompt if the target operation object matches none of the preset operation objects.

In an embodiment, the matching includes: requesting to re-receive the operation instruction or displaying an alarm prompt if the target operation category matches none of the preset operation categories.

In an embodiment, the preset response information is generated by: extracting lyrics data and melody data of the audio file from metadata, wherein the lyrics data comprises characters, the number of the characters and character time characteristics, and the melody data comprises a melody spectrum and a melody type; binding the lyrics data and the melody data to a lyrics special effects file that matches the lyrics data and the melody data, to form first special effects; binding the melody data to background special effects according to the melody type, to form second special effects; and binding the first special effects and the second special effects to generate the preset response information.

In an embodiment, the first special effects are formed by: acquiring of duration of a single character of the audio file, performing interval slicing on the duration, matching up lyric special effects with the lyrics data according to the slicing result, and binding the lyric special effects with the lyrics data to obtain the first special effects.

In an embodiment, the matching up lyric special effects with the lyrics data includes: anchoring the audio file based on the slicing result and rhythm recognition on the melody spectrum, wherein the audio file is provided with a plurality of anchor tags at its corresponding melody position and/or character position; and matching up the lyric special effects with the lyrics data based on a positional relationship of the anchor tags.

In an embodiment, the matching up the lyric special effects with the lyrics data based on a positional relationship of the anchor tags includes: matching up special effects with an audio file interval between two adjacent anchor tags according to density of the plurality of anchor tags and the slicing result, wherein the audio file matches a plurality of special effects on its timeline.

In an embodiment, the invoking preloaded special effects in the preset response information includes: adding the special effects in the preset response information to a special effects sequence, and adding the audio file to an audio sequence; determining whether the special effects sequence has been aligned with the audio sequence; regenerating the preset response information if determined that the special effects sequence has not aligned with the audio sequence; and simultaneously invoking the preset response information and the audio file of the same sequence according to the correspondence between the special effects sequence and the audio sequence, and adding the preset response information and the audio file of the same sequence to a playing queue.

In an embodiment, the displaying includes: after the audio file is loaded according to one or more pieces of preset response information, saving the one or more pieces of preset response information to the playing queue, determining whether to employ fast special effects, determining a queue length based on special effects relationship between the audio file and a next audio file in the playing queue, and determining connection special effects; and binding, the target lyrics to be changed to corresponding special effects for display and playing the audio file, based on the order of the playing queue.

In an embodiment, the determining whether to employ fast special effects includes: retrieving duration of a single character in the audio file and comparing the duration with a preset threshold; and secondary anchoring endpoints of which the number of characters exceeds the preset threshold within the preset display time, and reading the fast special effects.

In an embodiment, the secondary anchoring includes: establishing a density relationship between characters and time based on the preset display time; and traversing lyrics data along a timeline, and tagging two endpoints of an interval with a largest density relationship.

In an embodiment, preset response information in non-first order in the playing queue is processed with asynchronous threads. The connection special effects are inserted into an audio file that has not been completely played for transition after the operation instruction is received. The connection special effects start at a breakpoint of a previous song and end at a first anchor tag of a next song.

In an embodiment, the binding the target lyrics to be changed to corresponding special effects for display and playing the audio file includes: receiving an anchor tag of the audio file; loading the audio file and performing signal feedback and recording a first receiving time and a first sending time of the feedback after the anchor tag of the audio file is received, reading a next anchor tag of the audio file along the timeline and recording a second receiving time and a second feedback time after the audio file is loaded; and matching up endpoints of the second receiving time and the second feedback time with endpoints of a duration of the special effects, and determining timing of playing of next special effects data.

A display system is further provided according to the present disclosure. The display system is configured to perform the above display method. In an embodiment, the display system includes: a multimedia device, an interactive module, a storage module, a matching module, and a control module. The multimedia device is configured to receive user operation and display an audio file and a video. The interactive module is configured to be linked to the user operation or a signal. The storage module is configured to store a preset behavior library, a music library, and a special effects library. The matching module is configured to perform special effects matching and playing matching. The control module is configured to operate display elements of the multimedia device during playing to dynamically display images.

The beneficial effects of the present disclosure are as follows. The audio file is received and recognized. The image is associated with the sound, and therefore changes synchronously with the sound. The image is rhythmic and is in sync with the sound visually, thereby improving the audio-visual experience.

### BRIEF DESCRIPTION OF THE DRAWINGS

FIG. 1 is a schematic flowchart illustrating a display method for a multimedia device according to an embodiment of the present disclosure;

FIG. 2 is a schematic structural diagram illustrating a display system for a multimedia device according to an embodiment of the present disclosure;

FIG. 3 is a schematic diagram illustrating the operation instruction matching according to an embodiment of the present disclosure;

FIG. 4 is a schematic diagram illustrating lyrics special effects matching according to an embodiment of the present disclosure; and

FIG. 5 is a schematic flowchart illustrating the matching special effects sequences with audio sequences in a playing queue according to an embodiment of the present disclosure.

### DETAILED DESCRIPTION

The present disclosure will be further described in detail below in conjunction with embodiments, so that those skilled in the art can better understand the technical solutions of the present disclosure.

Users generally choose traditional speakers for playing audios, or choose smart speakers to interact with the speakers for conveniently control the speakers with sound. As smart devices advance, conveying information through sound alone is no longer enough to meet the entertainment needs of the public. Users are also expecting more personalized services and paying increasing attention to visual effects of products. There are currently some speakers that can display lyrics or provide a visual screen that changes with the rhythm. However, such speakers provide relatively simple display effects, and fail to reflect the correlation between the sound and the image. This is not enough to provide users with an immersive music experience. In the present disclosure, special effects are added to the lyrics on the screen to dynamically display the lyrics, as an audio-visual element that combines audio and video to enhance the appeal of the speakers and improve the user immersion and entertainment experience.

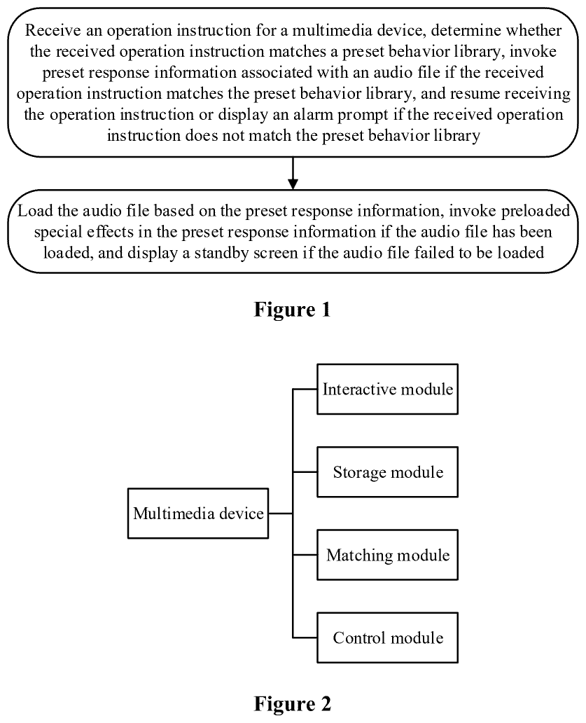

FIG. 1 is a schematic flowchart illustrating a display method for a multimedia device according to an embodiment. The multimedia device in this embodiment is a speaker equipped with a display screen for illustration. The method includes: receiving an operation instruction for the multimedia device, determining whether the received operation instruction matches a preset behavior library, invoking preset response information associated with an audio file if the received operation instruction matches the preset behavior library, and resuming receiving the operation instruction or displaying an alarm prompt if the received operation instruction does not match the preset behavior library; and loading the audio file based on the preset response information, invoking preloaded special effects in the preset response information if the audio file has been loaded, and displaying a standby screen if the audio file failed to be loaded.

In an optional scenario, the above solution is implemented as follows.

A multimedia device (for example, a speaker with a screen) turns on its screen and displays the standby screen after powered on. After audio operation command is selected by a user through the client terminal, the multimedia device matches the command with a preset user behavior for verification. If it is verified that the user is performing audio and/or video operations, association for the audio and the video is performed. This association means that special effects are added to the lyrics and/or melody of the audio file, to be displayed on the screen. After the association is finished, the corresponding associated data is generated and loaded. After the associated data has been loaded completely, the target lyrics that desired to be displayed dynamically are bound to the corresponding special effects for display, to replace the standby screen. In this way, the multimedia device gradually transitions from the standby screen a dynamic screen that matches the rhythm, the style, the length, the type and other elements of the audio file selected by the user, providing the user with an immersive audio-visual experience.

In the above solution, in response to the received operation instruction for the audio file, the operation instruction is matched with the preset behavior library as follows. Several preset operation instructions that can be received, recognized and executed are pre-stored in the preset behavior library. The preset operation instructions are individually loaded with preset operation categories and preset operation objects. The received operation instruction is matched up with the operation instructions in the preset behavior library. The preset behavior library refers to the way developers or manufacturers define the interaction between users and the multimedia device when producing the multimedia device or developing clients (small programs, APPs, remote control devices, etc.) that are matched with the multimedia device. When it is detected that the user interactive instruction matches the defined instruction, the program is executed following the corresponding rules.

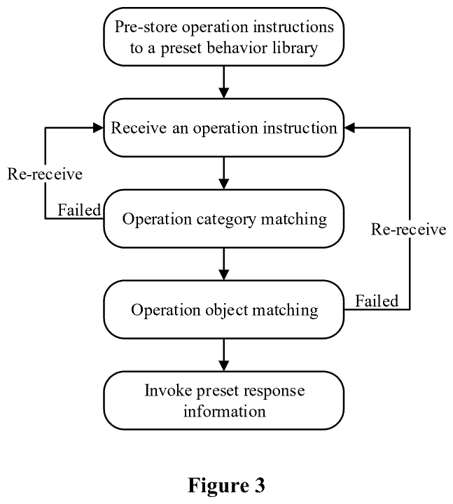

The purpose of the above matching is to make the response of the multimedia device more intelligent and accurate, and to avoid unwarranted responses that affect the playing of audio and display of video. Referring to FIG. 3, the operation instruction by the user is received. The operation category and the operation object in the instruction are extracted. If the operation category is successfully identified, the operation object is matched up with the preset operation objects. If the operation object successfully matches a preset operation object, the operation instruction is executed. If the operation object matches no preset operation object, no response is made. If the operation category is not identified, the operation object is not matched up with the preset operation objects. If the target object fails to match the preset operation object, it is requested to re-receive the operation instruction for the audio file or display alarm prompt. For example, a pop-up window prompts the user to perform proper operations, re-operation, etc. This embodiment does not limit the alarm prompt.

The operation category refers to the project behavior selected by the user. The operation object refers to the project target selected by the user. Considering the actual human-computer interaction scenario, the operation category includes: a wireless connection operation (such as Bluetooth, WIFI, etc.), a device selection operation (e.g., using client requests to connect to the multimedia device), a music selection operation (i.e., selecting the song to be played). The operation object includes: an audio file, a style, special effects and background. This embodiment does not limit the above category and/or object. The category and/or object may be developed and chosen based on implementation goals. In addition, the multimedia device may be used as an electronic photo album or photo frame for statically displaying images. Alternatively, instead of selecting an audio file, the white noise mode is triggered for the image to follow the decibels and weather conditions, etc.

In order to achieve the above-mentioned audio-visual association effect, the preset response information includes: an audio file and special effects associated with the audio file in this embodiment. The audio file described in this embodiment is stored in the music library in advance for invocation by the multimedia device. The audio file will not be modified. The audio file may be in common audio formats such as mp3, fly, or in a format as recommended by the music library service provider. This embodiment does not change the copyright of the song. The special effects described are pre-developed or downloaded and stored in the library. This embodiment does not specify the type and style of special effects, but rather provides a method for associating the audio and special effects.

This embodiment is implemented as follows. First, a connection to the metadata address is pre-established. The metadata address refers to a virtual service address of a music library and/or a database matched with a processor of the multimedia device. The library or database stores multiple data types of audio file. The data types include melody data, lyrics data, basic audio parameters and other data. The preset response information associated with an operation for the audio file is acquired, including: extracting the lyrics data and melody data of the audio file from the metadata. The lyrics data includes characters, number of characters, and character time characteristics (e.g., character duration based on LRC files). The melody data includes: melody spectrum and melody type. The lyrics data and the melody data are bond to a lyrics special effects file that matches the lyrics data and the melody data, to form first special effects. The melody data is bond to background special effects according to the melody type, to form second special effects. The first special effects and the second special effects are bond to generate the preset response information.

The above binding is performed through the special effects module. The special effects module is an application program developed in conjunction with the multimedia device. After recognizing the melody data and lyrics data, the special effects module invokes the special effects according to the corresponding rules to associate the special effects with the data of the audio file. The lyrics and songs are matched with respective special effects. The first special effects mentioned above are the lyrics special effects. The second special effects are the song special effects.

The above melody type refers to a tag of the song defined by creators, service providers or users, such as fast songs, slow songs, pop, ancient style, R&B, rap, jazz, cheerful, bitter and other conventional categories or moods in the music library. After the tag is read, special effects are matched to the background according to the preset melody type. For example, a song is tagged as a slow song, the corresponding song special effects are selected as background special effects such as a quiet forest or a beach under the breeze. For another example, a song is tagged as rock, the background effects are metal, punk, or other fast-paced backgrounds. During playing, the song special effects are used as the basis, and the upper layer displays the lyrics and the lyrics special effects according to the lyrics display rules, achieving an effect where the sound and image are synchronized.

Through the above solution, song special effects can be originally matched by melody type by default, or a new corresponding material library is retrieved according to the melody type customized by the user after use for matching the special effects with the melody type.

In this embodiment, the lyrics special effects are obtained by recognizing the lyrics text. The lyrics special effects mean that the lyrics are rendered on the screen display effect, such as dyeing, amplification, blurring, filling or covering, etc. based on the matching relationship between the data volume and the special effects, after reading the text in the audio file. According to the corresponding rules, different paragraphs and parts of the lyric text are provided with different effects for display, so as to improve the visual expression effect for users. The song special effects are background special effects on the display screen of the multimedia device and match the melody type, underlying the lyrics special effects.

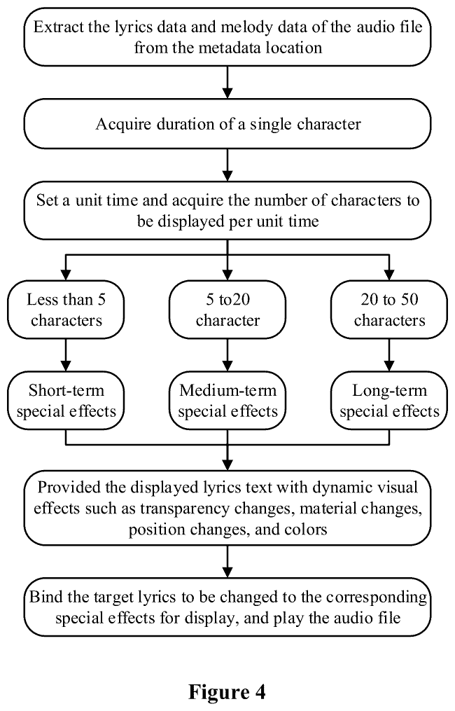

Referring to FIG. 4, in order to select the lyric special effects, the number of characters of the lyrics data and the duration of the melody spectrum are extracted, duration of a single character in the audio file is acquired, and then interval slicing is performed on the duration of the single character. Special effects matching the lyric data are selected based on the scribing result. That is, the lyrics is split into words or word queues to obtain the duration of the lyrics, the length of the lyrics, the proportion of letters in the lyrics, punctuation marks, the average interval between lyrics, etc. to select the special effects for the best visual experience. If it is recognized that less than 5 characters are to be displayed within a unit time, the lyrics is determined as short-term lyrics and short-term special effects are matched up to the for short-term lyrics. If it is recognized that 5 to 20 characters are to be displayed within a unit time, the lyrics is determined as medium-term lyrics and medium-term special effects are matched up to the for medium-term lyrics. If it is recognized that 20 to 50 characters are to be displayed within a unit time, the lyrics is determined as long-term lyrics and long-term special effects are matched up to the for long-term lyrics. If it is recognized that more than 50 characters are to be displayed within a unit time, the lyrics is determined as super long-term lyrics and super long-term special effects are matched up to the for super long-term lyrics. The displayed lyrics text is provided with dynamic visual effects such as transparency changes, material changes, position changes, and colors.

In this embodiment, the special effects are selected as follows. The audio file is anchored based on the slicing result and rhythm recognition on the melody spectrum. The audio file is provided with multiple anchor tags at its corresponding melody position and/or character position. Special effects are matched up with an audio file interval between two adjacent anchor tags according to density of the anchor tags and the slicing result. The audio file matches multiple special effects on its timeline.

It is understandable that a song contains parts such as intro, verse, chorus, bridge, etc. In some cases, the starting and ending points of these different parts are marked to facilitate special effects matching. For example, the intro has no lyrics and is matched with gentle special effect. As the lyrics are displayed, the background special effects change, and special effects that follow the lyrics are also displayed. The tagging logic of the above anchor tags is based on the transformation of rhythm and song parts. Alternatively, considering that some songs are at fast speaking speed and have too many characters to be displayed per unit time, characters are calibrated based on the anchor tags, to quickly adapts special effects to the unit time with a large amount of text, for better visual effects. The determination of whether to employ quick effects is as follows. Special effects are added to an audio file where the duration of a single character exceeds a preset threshold. The endpoint of the playing duration where the number of characters exceeds the preset threshold within the preset displaying time is secondary anchored, and is matched with fast special effects. Secondary anchoring refers to establishing the density relationship between characters and time based on the preset display time, traversing the lyrics data along the timeline, and tagging the two endpoints of the interval with the largest density relationship, and adding special effects to the interval.

Establishing the density relationship between characters and time means establishing a coordinate axis with playing time as the horizontal axis, lyrics density as the vertical axis, and calibrating the unit interval on the horizontal axis. The unit interval is a preset duration of one image. The lyrics data within this unit interval is read in LRC format and/or other preset formats. Based on the character amount of the lyrics data, the quantitative relationship between the unit interval and the character amount is obtained. On the coordinate axes, the unit area associated with the horizontal and vertical axes is obtained. The unit area changes with the character amount. The unit interval is shifted on the horizontal axis according to the preset step size, and the change in the unit area is recorded every time it is shifted, until an endpoint on the unit interval reaches the end of the playing time on the horizontal axis. The unit interval whose preset unit area is larger than the preset area is selected. It is determined that this interval contains a large amount of lyric text and needs to be quickly displayed with special effects. Anchor tags are marked at the two endpoints of the interval for quick special effects adaptation.

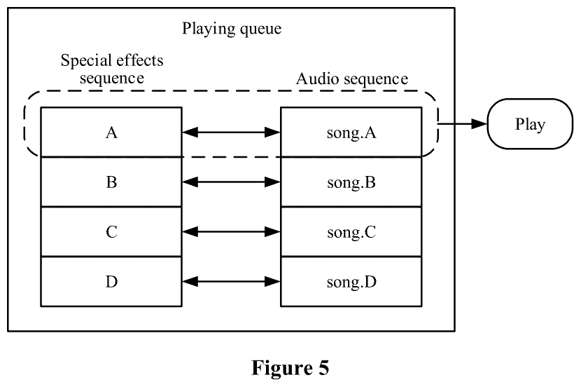

After completing the acquisition of the preset response information through the above solution, the special effects in the preset response information to the special effects sequence, and the audio file is added to the audio sequence, to form two columns of information buffers, as shown in FIG. 5. It is determined whether the special effects sequence has been aligned with the audio sequence. The preset response information is regenerated if determined that the special effects sequence has not aligned with the audio sequence. The preset response information and the audio file of the same sequence are invoked according to the correspondence between the special effects sequence and the audio sequence, and the preset response information and the audio file of the same sequence are added to the playing queue. In this way, the sound is in sync with the image.

During the playing, the multimedia device loads the audio file according to one or more pieces of preset response information, saves the one or more pieces of preset response information to the playing queue, determines the queue length based on the special effects relationship between an audio file and the next audio file in the playing queue, and determines the connection special effects. The connection special effects refer to transition special effects, which connect the song special effects and lyric special effects of the previous song with the song special effects and lyric special effects of the next song. Optionally, the connection special effects include fade-in, fly-out, gradient and the like. In addition, asynchronous threads are employed to process preset response information in non-first order in the playing queue to save core processor resources. After receiving the operation instruction, connection special effects are inserted into the audio file that has not been completely played for transition. The connection special effects start at the breakpoint of the previous song and end at the first anchor tag of the next song.

After the special effects and the playing queue are prepared, the multimedia device first receives the anchor tag of the audio file, then loads the audio file and performs signal feedback, and records the first receiving time and first sending time of the feedback. After loading the audio file, the multimedia device reads the next anchor tag of the audio file along the timeline, and records the second receiving time and the second feedback time. The multimedia device matches up endpoints of the second receiving time and the second feedback time with endpoints of the preset duration of the special effects, and determines timing of the playing of the next special effects data to synchronously control the sound and the image, thereby avoiding asynchronization between the image and the sound which affect user experience.

In this embodiments, the audio file is received and recognized. The image is associated with the sound, and therefore changes synchronously with the sound. The image is rhythmic and is in sync with the sound visually, thereby improving the user audio-visual experience.

FIG. 2 is a schematic structural diagram illustrating a display system for a multimedia device according to an embodiment of the present disclosure. The display system is configured to perform the above display method. The display system includes: a multimedia device, an interactive module, a storage module, a matching module, and a control module. The multimedia device is configured to receive user operation and display an audio file and a video. The interactive module is configured to be linked to the user operation or a signal. The storage module is configured to store a preset behavior library, a music library, and a special effects library. The matching module is configured to perform special effects matching and playing matching. The control module is configured to operate display elements of the multimedia device during playing to dynamically display images.

Only preferred embodiments of the present disclosure have been described above. It should be noted that the preferred embodiments should not be regarded as limitations of the present disclosure. Instead, protection scope of the present disclosure shall be subject to the scope defined by the claims. For those of ordinary skill in the art, several improvements and modifications can be made without departing from the spirit and scope of the present disclosure. These improvements and modifications should also fall into the protection scope of the present disclosure.

1. A display method for a multimedia device, comprising:
receiving an operation instruction for the multimedia device, determining whether the received operation instruction matches a preset behavior library, invoking preset response information associated with an audio file if the received operation instruction matches the preset behavior library, and resuming receiving the operation instruction or displaying an alarm prompt if the received operation instruction does not match the preset behavior library; and
loading the audio file based on the preset response information, invoking preloaded special effects in the preset response information if the audio file has been loaded, and displaying a standby screen if the audio file failed to be loaded.

2. The display method according to claim 1, wherein
the preset behavior library comprises a plurality of preset operation instructions individually loaded with preset operation categories and preset operation objects; and
the operation instruction for the multimedia device is loaded with a target operation category and a target operation object.

3. The display method according to claim 2, wherein the matching comprises:
receiving a target operation instruction for the audio file, and acquiring a target operation category and a target operation object;
determining whether the target operation object matches one of the preset operation objects after determined that the target operation category matches the corresponding preset operation category;
invoking the preset response information associated with the audio file if the target operation object matches a preset operation object; and
requesting to re-receive the operation instruction or display an alarm prompt if the target operation object matches none of the preset operation objects.

4. The display method according to claim 2, wherein the matching comprises:
requesting to re-receive the operation instruction or displaying an alarm prompt if the target operation category matches none of the preset operation categories.

5. The display method according to claim 1, wherein the preset response information is generated by:
extracting lyrics data and melody data of the audio file from metadata, wherein the lyrics data comprises characters, the number of the characters and character time characteristics, and the melody data comprises a melody spectrum and a melody type;
binding the lyrics data and the melody data to a lyrics special effects file that matches the lyrics data and the melody data, to form first special effects;
binding the melody data to background special effects according to the melody type, to form second special effects; and
binding the first special effects and the second special effects to generate the preset response information.

6. The display method according to claim 5, wherein the first special effects are formed by:
acquiring of duration of a single character of the audio file, performing interval slicing on the duration, matching up lyric special effects with the lyrics data according to the slicing result, and
binding the lyric special effects with the lyrics data to obtain the first special effects.

7. The display method according to claim 6, wherein the matching up lyric special effects with the lyrics data comprises:
anchoring the audio file based on the slicing result and rhythm recognition on the melody spectrum, wherein the audio file is provided with a plurality of anchor tags at its corresponding melody position and/or character position; and
matching up the lyric special effects with the lyrics data based on a positional relationship of the anchor tags.

8. The display method according to claim 7, wherein the matching up the lyric special effects with the lyrics data based on a positional relationship of the anchor tags comprises:
matching up special effects with an audio file interval between two adjacent anchor tags according to density of the plurality of anchor tags and the slicing result, wherein the audio file matches a plurality of special effects on its timeline.

9. The display method according to claim 1, wherein the invoking preloaded special effects in the preset response information comprises:
adding the special effects in the preset response information to a special effects sequence, and
adding the audio file to an audio sequence;
determining whether the special effects sequence has been aligned with the audio sequence;
regenerating the preset response information if determined that the special effects sequence has not aligned with the audio sequence; and
simultaneously invoking the preset response information and the audio file of the same sequence according to the correspondence between the special effects sequence and the audio sequence, and adding the preset response information and the audio file of the same sequence to a playing queue.

10. The display method according to claim 9, wherein displaying comprises: after the audio file is loaded according to one or more pieces of preset response information,
saving the one or more pieces of preset response information to the playing queue, determining whether to employ fast special effects, determining a queue length based on special effects relationship between the audio file and a next audio file in the playing queue, and determining connection special effects; and
binding, the target lyrics to be changed to corresponding special effects for display and playing the audio file, based on the order of the playing queue.

11. The display method according to claim 10, wherein the determining whether to employ fast special effects comprises:
retrieving duration of a single character in the audio file and comparing the duration with a preset threshold; and
secondary anchoring endpoints of which the number of characters exceeds the preset threshold within the preset display time, and reading the fast special effects.

12. The display method according to claim 11, wherein the secondary anchoring comprises:
establishing a density relationship between characters and time based on the preset display time; and
traversing lyrics data along a timeline, and tagging two endpoints of an interval with a largest density relationship.

13. The display method according to claim 9, wherein
preset response information in non-first order in the playing queue is processed with asynchronous threads; and
the connection special effects are inserted into an audio file that has not been completely played for transition after the operation instruction is received, wherein the connection special effects start at a breakpoint of a previous song and end at a first anchor tag of a next song.

14. The display method according to claim 9, wherein the binding the target lyrics to be changed to corresponding special effects for display and playing the audio file comprises:
receiving an anchor tag of the audio file;
loading the audio file and performing signal feedback and recording a first receiving time and a first sending time of the feedback after the anchor tag of the audio file is received, reading a next anchor tag of the audio file along the timeline and recording a second receiving time and a second feedback time after the audio file is loaded; and
matching up endpoints of the second receiving time and the second feedback time with endpoints of a duration of the special effects, and determining timing of playing of next special effects data.

15. A display system, configured to perform the display method according to claim 1, and the display system comprising:
a multimedia device configured to receive user operation and display an audio file and a video;
an interactive module configured to be linked to the user operation or a signal;
a storage module configured to store a preset behavior library, a music library, and a special effects library;
a matching module configured to perform special effects matching and playing matching; and
a control module configured to operate display elements of the multimedia device during playing to dynamically display images.
